(19) United States
(12) Patent Application Publication
(10) Pub. No.: US 2015/0061438 A1
(43) Pub. Date: Mar. 5, 2015

(54) MAGNET CO-FORMED TO BACK IRON

(71) Applicant: SEAGATE TECHNOLOGY LLC, Cupertino, CA (US)

(72) Inventors: Hans Leuthold, Santa Cruz, CA (US); Chris M. Woldemar, Santa Cruz, CA (US); Norbert Steven Parsoneault, Boulder, CO (US)

(73) Assignee: SEAGATE TECHNOLOGY LLC, Cupertino, CA (US)

(21) Appl. No.: 14/018,755

(22) Filed: Sep. 5, 2013

(51) Int. Cl. H02K 1/27

(52) U.S. Cl. CPC H02K 1/2706
USPC 310/91; 310/156.38

(57) ABSTRACT

An apparatus includes a hub. The apparatus also includes a back iron that is coupled to the hub. In addition, a magnetic annulus is co-formed to the back iron.

### BACKGROUND

An electric motor may use stators, magnets, and/or coils to rotate an object. For example, a motor may rotate data storage disks used in a disk drive storage device. The data storage disks may be rotated at high speeds during operation using the stators, magnets, and/or coils. For example, magnets and coils may interact with a stator to cause rotation of the disks relative to the stator.

In some cases, electric motors are manufactured with increasingly reduced sizes. For example, in order to reduce the size of a disk drive storage device, the size of various components of the disk drive storage device may be reduced. Such components may include the electric motor, stator, magnets, and/or coils. The precision at which the stators, magnets, and coils are manufactured can affect the acoustical properties and performance of the electric motor.

### SUMMARY

An apparatus includes a hub. The apparatus also includes a back iron that is coupled to the hub. In addition, a magnetic annulus is co-formed to the back iron.

These and other aspects and features of embodiments may be better understood with reference to the following drawings, description, and appended claims.

### BRIEF DESCRIPTION OF DRAWINGS

The present invention is illustrated by way of example, and not by way of limitation, in the figures of the accompanying drawings and in which like reference numerals refer to similar elements.

FIG. 1 provides a top perspective of a number of stator teeth, magnetic annulus, and a back iron, according to one aspect of the present embodiments.

FIG. 2 provides a cross-sectional perspective of an exemplary back iron and hub, according to one aspect of the present embodiments.

FIG. 3 provides a cross-sectional perspective of a stator tooth, a back iron, a magnetic annulus co-formed to the back iron, and a hub, according to one aspect of the present embodiments.

FIG. 4 provides a cross-sectional perspective of a back iron, a magnetic annulus co-formed to the back iron and a hub, according to one aspect of the present embodiments.

FIGS. 5A and 5B provide a cross-sectional perspective of co-forming a magnet to a back iron, using a mold, according to one aspect of the present embodiments.

FIGS. 6A and 6B provide a cross-sectional perspective of a first magnet and a second magnet, both co-formed to a back iron, according to one aspect of the present embodiments.

FIG. 6C provides a cross-sectional perspective of a magnet, a back iron, and a clamshell tool, according to one aspect of the present embodiments.

FIG. 6D provides a cross-sectional perspective of a hub, a first back iron with a first magnet, and a second back iron with a second magnet, according to one aspect of the present embodiments.

FIG. 7 shows an exemplary flow diagram for co-forming a magnet to a back iron, according to one aspect of the present embodiments.

FIG. 8 provides a plan view of a conventional hard disk drive in which embodiments of one or more magnets co-formed to a back iron may be used.

### DETAILED DESCRIPTION

Before various embodiments are described in greater detail, it should be understood that the embodiments are not limited to the particular embodiments described and/or illustrated herein, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

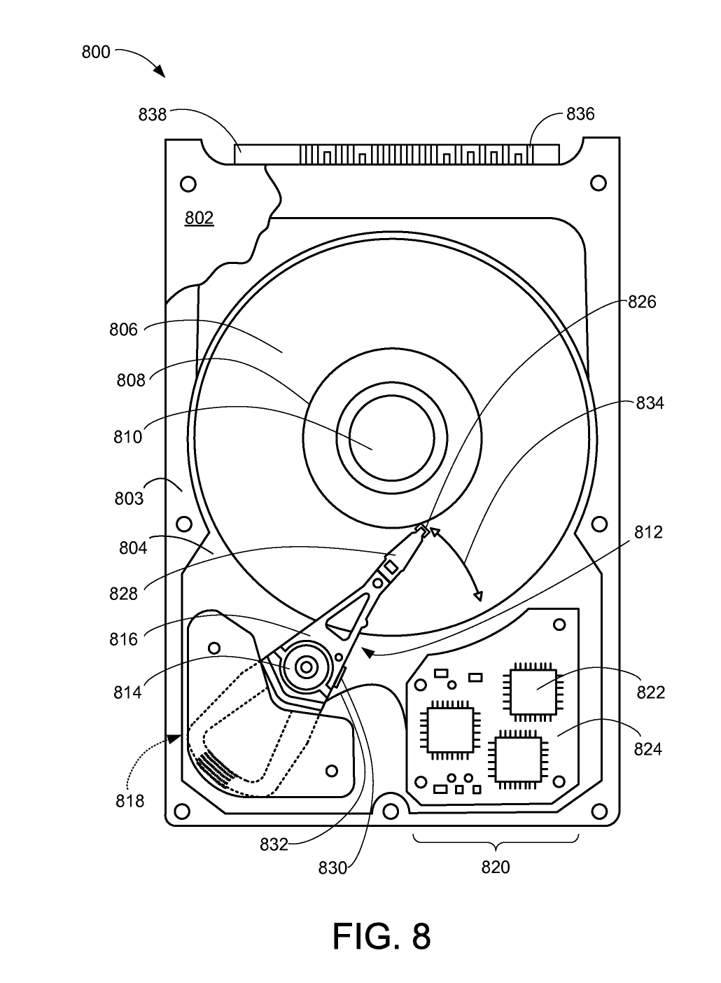

Disks of a hard disk drive (“HDD”), such as that of FIG. 8 described herein below, may be rotated at high speeds by means of an electric motor including a spindle assembly mounted on a base of a housing. Such electric motors include a stator assembly including a number of stator teeth, each extending from a yoke. Each stator tooth of the number of stator teeth supports a field coil that may be energized to polarize the field coil. Such electric motors further include one or more permanent magnets disposed adjacent to the number of stator teeth. As the number of field coils disposed on the number of stator teeth are energized in alternating polarity, the magnetic attraction or repulsion of a field coil to an adjacent permanent magnet causes the spindle of the spindle motor assembly to rotate, thereby rotating the disks for read/write operations by one or more read-write heads.

Various means may be used to attach a permanent magnet to a motor part (e.g., base, back iron, etc.). Glue may be used thereby introducing a constructive “gap” (e.g., the space filled by the glue) between the magnet and the motor part. This gap thus wastes space thereby adding to the dimensions of the device.

If a magnet is formed separate from a motor part, the magnet may not be as round as the motor part to which the magnet is attached (e.g. back iron, hub). Another variance may be created by a variation in the gap going around the circumference created by the magnetic. For example, the magnetic nature of the magnet may cause the magnet to unevenly attach to a motor part, thereby being off center. In other words, the magnetic nature of the magnet causes the magnet to lock to one side of the motor part. These variances between the motor part and magnet cause the magnet to be eccentric, thereby causing non-uniform electromagnetic forces during operation and/or resulting in acoustical issues. As a result, the magnet and motor part manufacture may be restricted to a tolerance range in order to limit eccentricities and/or acoustical issues.

A protective coating may be applied after assembly of the magnet and motor part. The protective coating may prevent a portion of the magnet or other motor parts from separating and damaging a magnetic storage disk. For example, if magnetic material comes into contact with a magnetic disk, a catastrophic error on the magnetic disk may result. This coating adds thickness, and the thickness may not be even from part to part. The variances in the coating can cause problems (e.g. vibration, acoustic, etc.) during the rotation of electric motor components. Additionally, this coating further consumes space thereby adding to the dimensions of the device.

On the other hand, co-forming the magnet onto a motor part (e.g., back iron) allows a substantially rounder magnet, thereby reducing variances and associated tolerances. In addition, co-forming the magnet to one or more motor parts while reducing the gap, allows a reduction in the size of the device and recovery of usable space. Further, the magnet may be reduced in thickness, while maintaining loop strength and reducing the gap between the magnet and the motor part. Thus, co-forming of the magnet to another motor component substantially eliminates the distance (e.g., caused by glue) between the magnet and the motor component and allows reducing the magnet thickness. The co-forming of the magnet to another motor component (e.g., back iron) further allows for elimination of a coating layer where the magnet is in contact with the motor component (e.g., on a surface of the magnet in contact with a portion of a surface of the back iron).

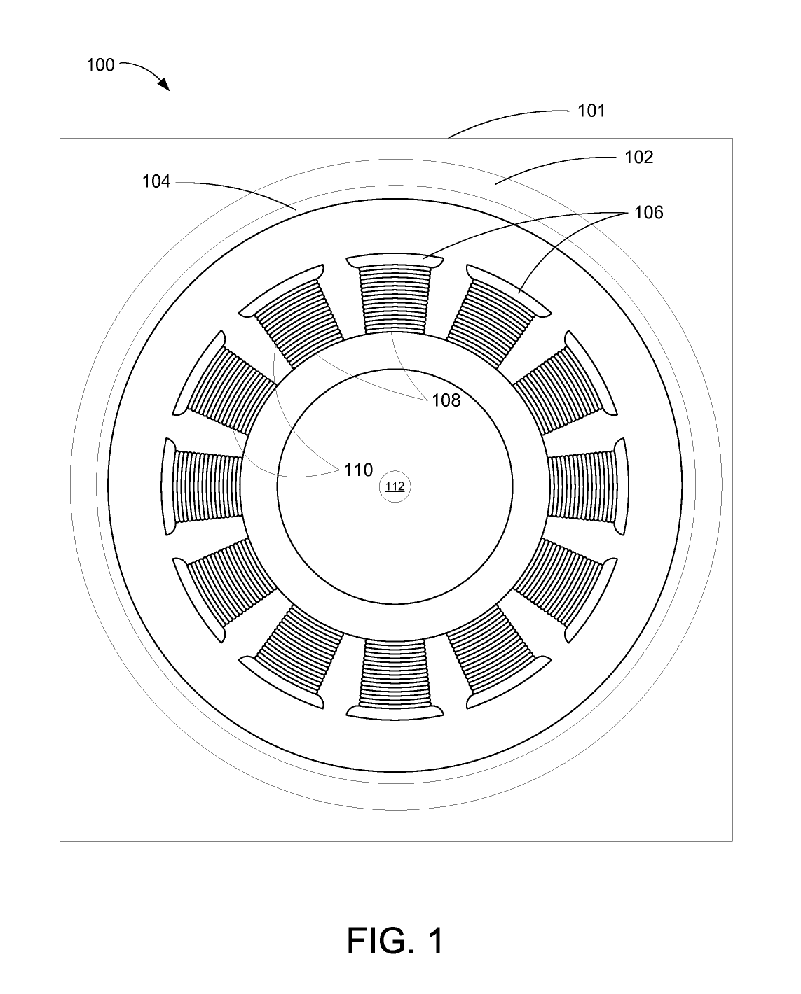

FIG. 1 provides a top perspective of a number of stator teeth, magnetic annulus, and a back iron, according to one aspect of the present embodiments. Portion of electric motor 100 includes base 101, back iron 102, magnetic annulus 104, stator teeth 106, yoke 108, field coils 110, and shaft 112. Stator teeth 106 may be part of a stator assembly which is supported by the base 101 (e.g., base deck of FIG. 8). In one embodiment, magnetic annulus 104 is co-formed on back iron 102 thereby removing gaps and variances between magnetic annulus 104 and back iron 102. Magnetic annulus 104 includes magnetic material, for example, neodymium, boron, iron, or a combination thereof.

Field coils 110 are coupled to the yoke 108. Stator teeth 106 are coupled to (e.g., mounted on) yokes 108. Field coils 110 cause stator teeth 106 to output a magnetic field. The magnetic field causes magnetic annulus 104 to be pushed and pulled relative to stator teeth 106, thereby causing magnetic annulus 104 to rotate. The rotation of magnetic annulus 104 causes back iron 102 to rotate and motor components coupled to back iron 102 (e.g., a hub) to rotate. For example, the rotation of magnetic annulus 104 may cause a hub to rotate about an axis normal to the base (e.g., rotate about shaft 112). Back iron 102 closes magnetic flux from the stator teeth, thereby preventing a magnetic field generated by field coils 110 from extending to a magnetic data storage area (e.g., magnetic disk).

In one embodiment, a stator assembly including stator teeth 106 may have a diameter of 16 mm, for example. The gap between stator teeth 106 and magnetic annulus 104 may be approximately 250 microns or ⅓ of a millimeter, for example. The outer diameter of a hub coupled to back iron 102 may be 20 mm, for example.

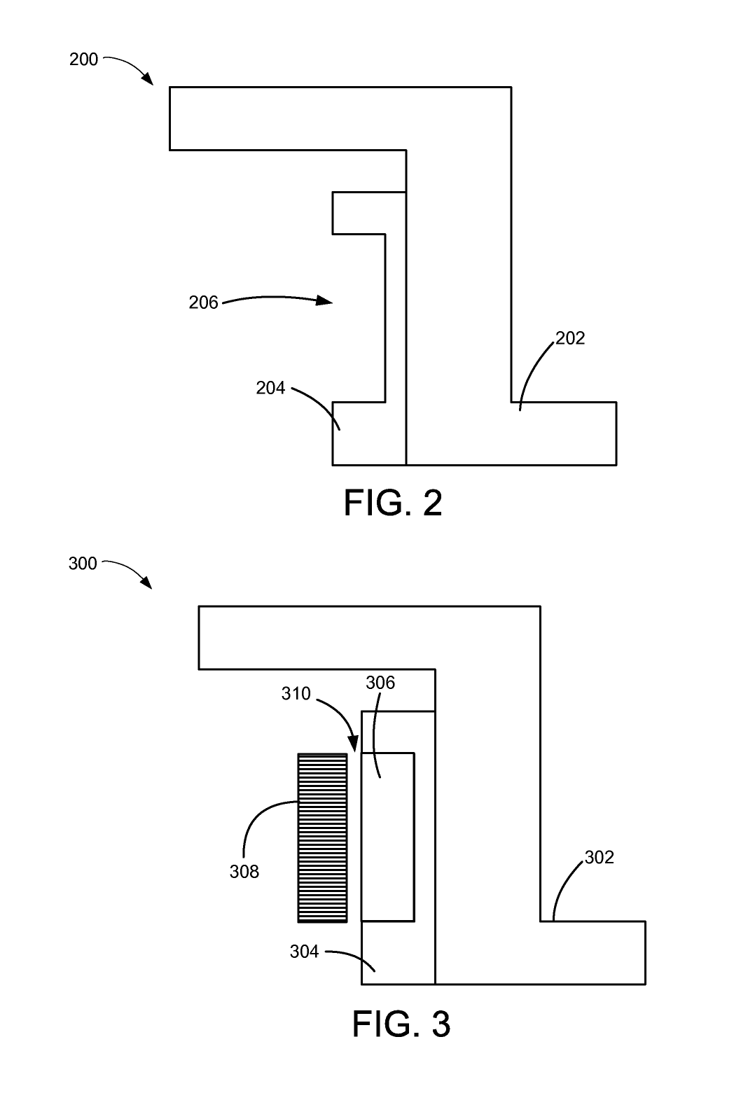

FIG. 2 provides a cross-sectional perspective of an exemplary back iron and hub, according to one aspect of the present embodiments. Portion of electric motor 200 includes hub 202 and back iron 204. Back iron 204 is coupled to hub 202. Back iron 204 may be pressed, slipped, or adhered (e.g. glue or adhesive) onto hub 202. In some embodiments, the back iron 204 is separate from the hub 202 until after co-forming a magnet (e.g. magnetic annulus 104) to the back iron 204. Thus, the back iron 204 includes the magnet when it is coupled to the hub 202. In one exemplary embodiment, back iron 204 includes an annular channel or cavity 206 for a magnet to be co-formed into.

Back iron 204 may thereby provide structural strength to a magnet co-formed to back iron 204. In one embodiment, the material (e.g., steel) used for back iron 204 is stronger and cheaper than magnetic material, thereby providing support to the magnetic material. For example, the magnetic material may be magnetized by exposing the magnetic material to a strong magnetic field. This strong magnetic field can create forces that may distort or pull apart a magnet with insufficient strength. Thus, forming of the magnet on back iron allows the back iron to provide structural support to the magnet, thereby allowing the magnet to be thinner while being strong enough to withstand the forces created during the magnetization process. In one embodiment, higher grade magnetic material (e.g., grades of 12 and above) is used to provide sufficient magnetic properties while using less magnetic material. In various embodiments, the reduction in space occupied by the magnet may be used for the back iron, thereby allowing a structurally stronger back iron. In some embodiments, the reduction in space occupied by the magnet may also be used to change the size of the gap (e.g., air gap) between stator teeth and a magnetic annulus. In various embodiments, the reduced size of the magnet may allow for smaller overall motor design, or larger and/or smaller motor components (e.g. stator, sleeve, hub, limiter, etc.).

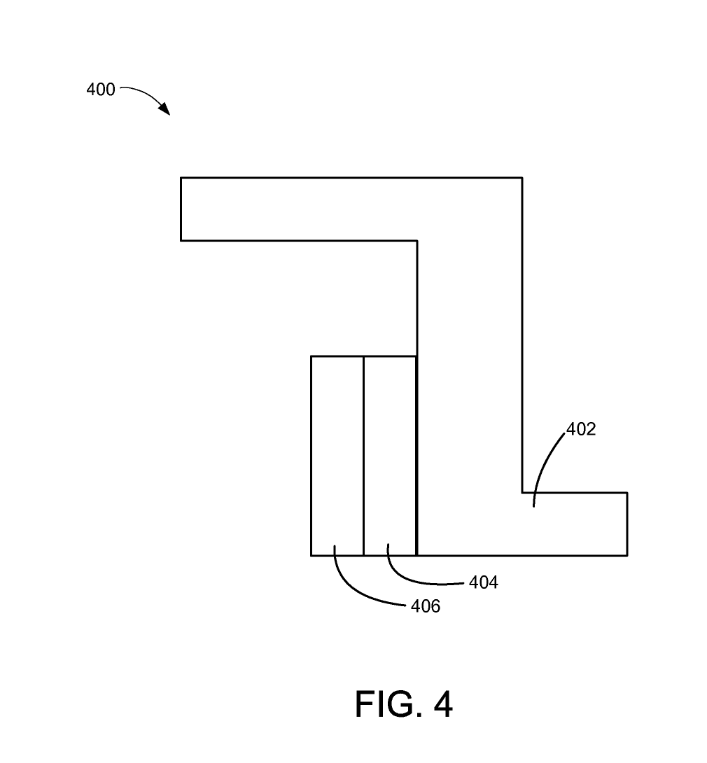

FIG. 3 provides a cross-sectional perspective of a stator tooth, a back iron, a magnetic annulus co-formed to the back iron and a hub, according to one aspect of the present embodiments. Portion of electric motor 300 includes hub 302, back iron 304, magnet 306, and stator tooth 308.

Back iron 304 is coupled to hub 302. Magnet 306 is co-formed to back iron 304. Magnet 306 is formed into an annular channel or annular cavity of back iron 304. In some embodiments, back iron 304 is coupled to three sides of magnet 306 (e.g. top, bottom, and outer diameter). However, in various embodiments the back iron 304 may couple to any number of sides, portions of one or more sides, or combinations of sides and/or portions of sides of the magnet 306. Furthermore, in several embodiments the magnet 306 and/or back iron 304 may include various shapes. For example, the top and/or bottom and/or sides of the magnet 306 and/or cavity 206 (FIG. 2) of the back iron 304 may be rounded, include protrusions, and/or include indentations.

Magnet 306 is separated from stator tooth 308 by gap 310. Stator tooth 308 creates a magnetic field that causes magnet 306 to rotate thereby rotating hub 302. In one embodiment, stator tooth 308 may have different dimensions (e.g., height) than dimensions of magnet 306. In further embodiments, the stator tooth 308 and the magnet 306 may be axially offset from one another. For example, the center of the magnet 306 may be higher than the center of the stator, thereby providing a magnetic bias to the electric motor 300.

In various embodiments, gap 310 between the stator tooth and the magnet may be between, for example, 150-300 microns. Some embodiments reduce the variance on the gap between the stator teeth and the magnet by having a co-formed magnet that is substantially uniform in shape with respect to back iron 304. For example, the gap between the stator teeth and magnet may vary less than 5%, thereby substantially reducing or substantially eliminating acoustic tones during operation of the electric motor.

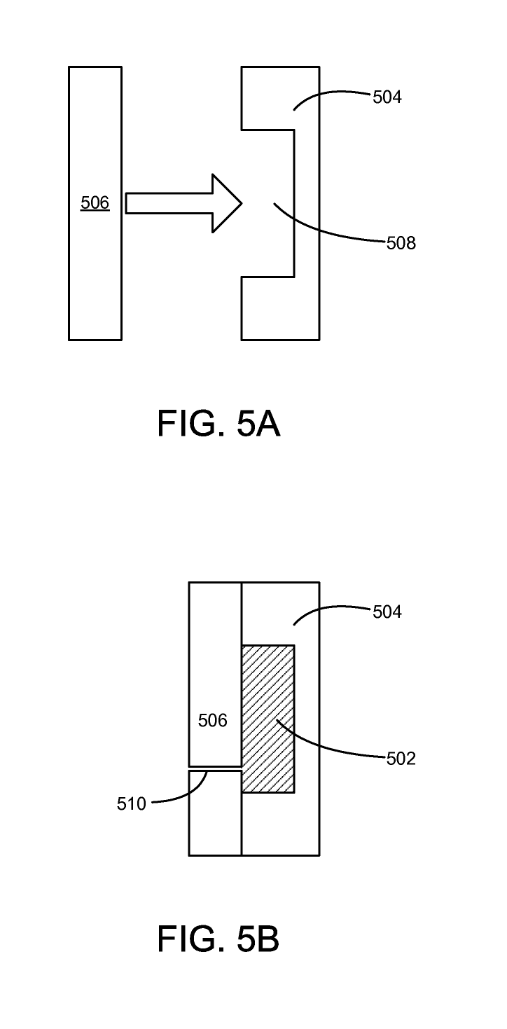

FIG. 4 provides a cross-sectional perspective of a back iron, a magnetic annulus co-formed to the back iron and a hub, according to one aspect of the present embodiments. Electric motor portion 400 includes hub 402, back iron 404, and magnet 406. Magnet 406 is co-formed on back iron 404. In one embodiment, magnet 406 may not be co-formed into a channel or cavity of back iron 404. For example, magnet 406 may be co-formed onto a side of back iron 404.

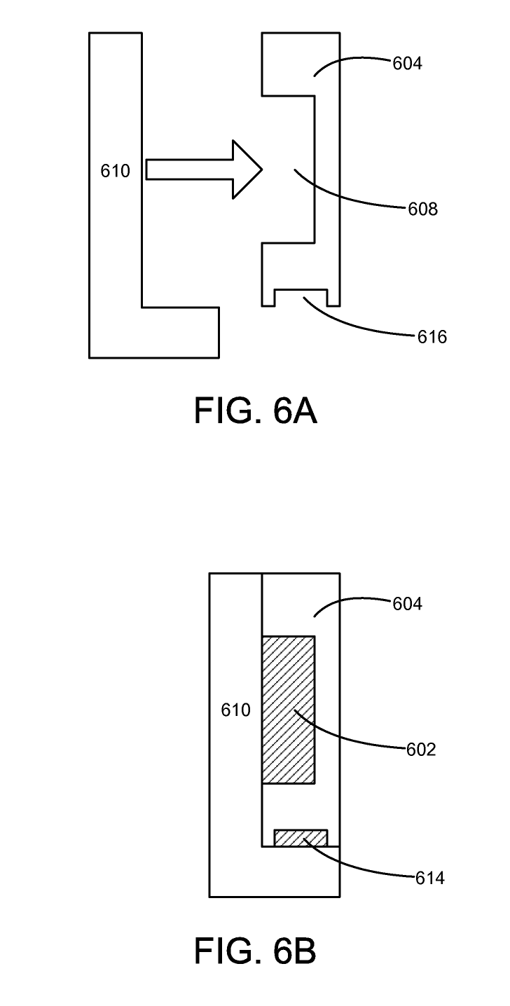

FIGS. 5A and 5B provide a cross-sectional perspective of co-forming a magnet 502 to a back iron 504, using a mold 506, according to one aspect of the present embodiments. In various embodiments, the magnet 502 may be co-formed to the back iron 504 before the back iron 504 is attached to the hub 302 (FIG. 3).

In various embodiments, magnet 502 may be co-formed by using back iron 504 as a molding component (e.g., clamshell mold). Back iron 504 (e.g. 4/16″ or 4/30″ steel) may be half of a clamshell mold, thereby supporting the top and bottom of the magnet 502. The other half may be mold 506. Back iron 504 and mold 506 may be moved together, forming mold cavity 508. The magnet 502 may then be co-formed to the back iron 504, and the mold 506 is removed, thereby leaving the magnet 502 co-formed to the back iron 504. For example, material may be injected into the cavity 508, through a channel 510. The material may be co-formed to the back iron 504, the mold 506 removed, and the material magnetized in further processes, thereby forming the magnet 502. After the material has been formed into magnet 502, the co-formed magnet 502 and back iron 504 are secured (e.g. glued, press fitted, welded, etc.) to the hub 302 (FIG. 3).

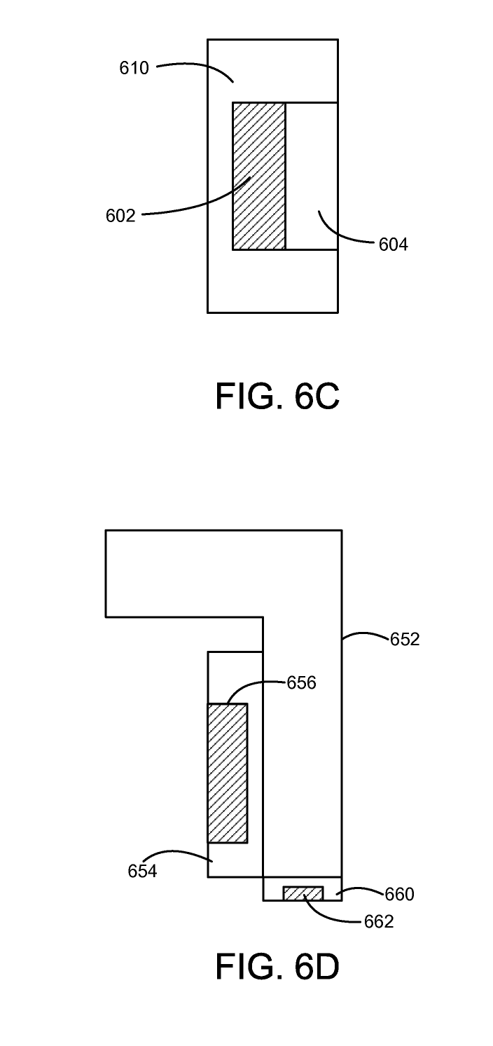

FIGS. 6A and 6B provide a cross-sectional perspective of a first magnet 602 and a second magnet 614, both co-formed to back iron 604, according to one aspect of the present embodiments. First magnet 602 is co-formed into first mold cavity 608, and second magnet 614 is co-formed into second mold cavity 616 of back iron 604 by tool 610. Tool 610 may be a tool or machine operable to apply, inject, extrude, or attach magnetic material to back iron 604. Back iron 604 provides structural support and strength to first magnet 602 and second magnet 614 during the magnetization process and the co-forming process, thereby allowing first magnet 602 and second magnet 614 to be thinner.

First magnet 602 and second magnet 614 are annular in shape. First magnet 602 is operable to cause rotation of a motor part (e.g., caused by stator teeth 106, FIG. 1). Second magnet 614 is formed in a bottom portion (e.g. second mold cavity 616) of back iron 604. Thus, second magnet 614 is configured for axial biasing of a motor part (e.g., hub 302, FIG. 3). First magnet 602, second magnet 614, and back iron 604 may be surrounded by a protective coating after being magnetized.

FIG. 6C provides a cross-sectional perspective of a magnet 602, a back iron 604, and a clamshell tool 610, according to one aspect of the present embodiments. In the present embodiment, tool 610 is clamshell shaped, instead of the back iron 604. Thus, the clamshell shaped tool 610 is combined with the back iron 604 to form a cavity in which the magnet 602 is co-formed onto the back iron 604. As a result, the clamshell shaped tool 610 supports the magnet 602 on the top and bottom during co-forming, instead of the back iron supporting the top and bottom of the magnet (see FIGS. 5A and 5B).

FIG. 6D provides a cross-sectional perspective of a hub 652, a first back iron 654 with a first magnet 656, and a second back iron 660 with a second magnet 662, according to one aspect of the present embodiments. Back irons 654 and 660 are coupled to hub 652. First magnet 656 has been co-formed onto first back iron 654, and second magnet 662 has been co-formed onto second back iron 660. First magnet 656 and second magnet 662 may be co-formed onto first back iron 654 and second back iron 660 by a tool or machine (e.g., tool 610). First magnet 656 may be operable to cause rotation of a motor part (e.g., caused by stator teeth 106, FIG. 1). Second magnet 662 may be operable for axial biasing of a motor part (e.g., hub 652).

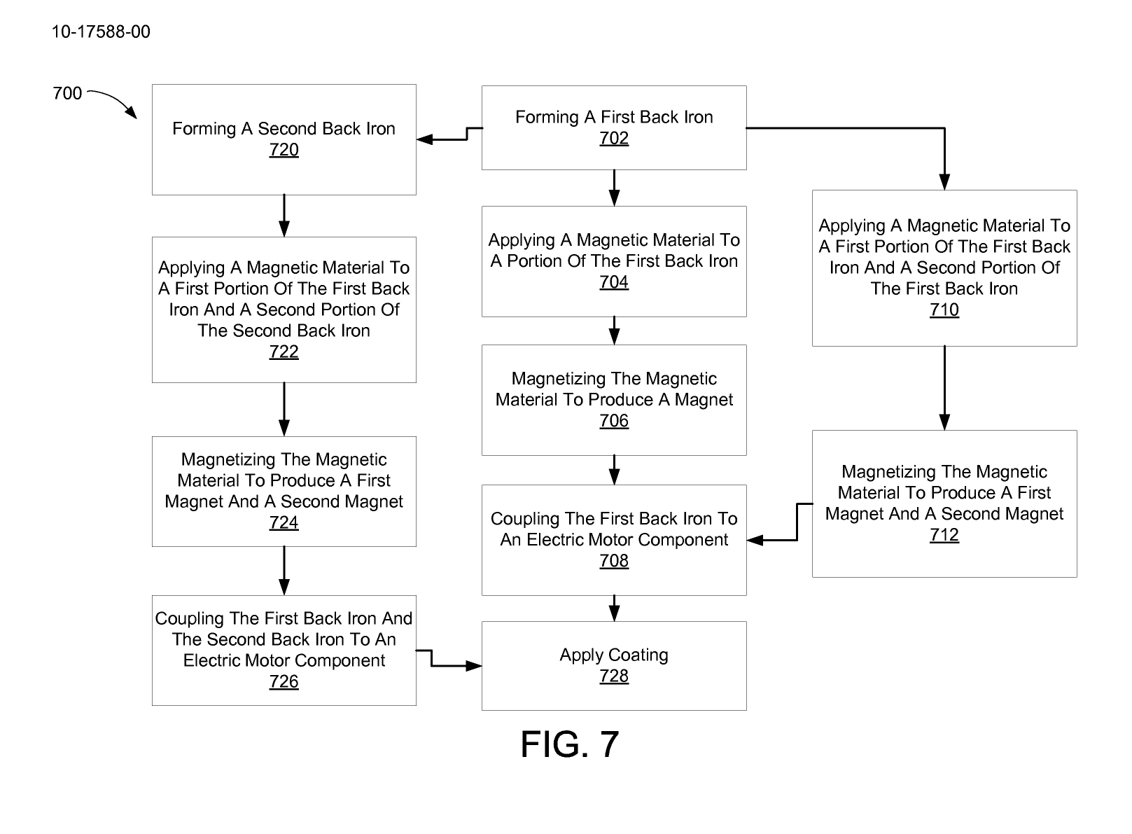

FIG. 7 shows an exemplary flow diagram for co-forming a magnet to a back iron, according to one aspect of the present embodiments. Flow diagram 700 depicts various processes in accordance with forming various embodiments for co-forming one or more magnets onto one or more back irons.

At block 702, a first back iron is formed. The first back iron may be formed of steel.

At block 704, a magnetic material is applied to a portion of the first back iron. The magnetic material may be applied, injected, or extruded (e.g., directly) into an annular cavity or channel of the back iron. In one embodiment, the magnetic material is applied to the back iron with a mold (e.g., FIGS. 5A and 5B).

At block 706, the magnetic material is magnetized to produce a magnet. In one embodiment, the magnetic material is magnetized by exposing the magnetic material to a magnetic field while heating the magnetic material and the back iron.

At block 708, the first back iron is coupled to an electric motor component (e.g., a hub). The first back iron may be adhered/glued onto, pressed onto, or slipped onto a hub.

At block 710, a magnetic material is applied to a first portion of the first back iron and a second portion of the back iron. In one embodiment, the back iron includes a second cavity (e.g., on a bottom portion of the back iron) and the magnetic material is applied into the second cavity (e.g., FIGS. 6A and 6B).

At block 712, the magnetic material is magnetized to produce a first magnet and a second magnet (e.g., magnets 602 and 614).

At block 720, a second back iron is formed. The second back iron may be formed of steel.

At block 722, a magnetic material is applied to a first portion of the first back iron and a second portion of the second back iron (e.g., FIGS. 6A and 6B).

At block 724, the magnetic material is magnetized to produce a first magnet and a second magnet.

At block 726, the first back iron and the second back iron are attached to a electric motor component (e.g., hub). In one embodiment, the second back iron is coupled to a bottom portion of a motor component (e.g., hub as in FIG. 6B).

At block 728, a coating is applied to the one or more magnets and an electric motor component (e.g., one or more back irons). The coating may be applied around and/or surround the one or more back irons and the one or more magnets thereby acting as a protective coating during operation of the electric motor.

FIG. 8 provides a plan view of a hard disk drive 800, which hard disk drive may use the co-formed magnet(s) described herein. Hard disk drive 800 may include a housing assembly including a cover 802 that mates with a base deck having a frame 803 and a floor 804, which housing assembly provides a protective space for various hard disk drive components. The hard disk drive 800 includes one or more data storage disks 806 of computer-readable data storage media. Typically, both of the major surfaces of each data storage disk 806 include a number of concentrically disposed tracks for data storage purposes. Each data storage disk 806 is mounted on a hub 808, which in turn is rotatably interconnected with the base deck and/or cover 802. The hub 808 may include one or more magnets that have been co-formed onto a back iron (as described above). Multiple data storage disks 806 are typically mounted in vertically spaced and parallel relation on the hub 808. A spindle motor assembly 810 rotates the data storage disks 806.

The hard disk drive 800 also includes an actuator arm assembly 812 that pivots about a pivot bearing 814, which in turn is rotatably supported by the base deck and/or cover 802. The actuator arm assembly 812 includes one or more individual rigid actuator arms 816 that extend out from near the pivot bearing 814. Multiple actuator arms 816 are typically disposed in vertically spaced relation, with one actuator arm 816 being provided for each major data storage surface of each data storage disk 806 of the hard disk drive 800. Other types of actuator arm assembly configurations could be utilized as well, an example being an “E” block having one or more rigid actuator arm tips, or the like, that cantilever from a common structure. Movement of the actuator arm assembly 812 is provided by an actuator arm drive assembly, such as a voice coil motor 818 or the like. The voice coil motor 818 is a magnetic assembly that controls the operation of the actuator arm assembly 812 under the direction of control electronics 820. The control electronics 820 may include a number of integrated circuits 822 coupled to a printed circuit board 824. The control electronics 820 may be coupled to the voice coil motor assembly 818, a slider 826, or the spindle motor assembly 810 using interconnects that can include pins, cables, or wires (not shown).

A load beam or suspension 828 is attached to the free end of each actuator arm 816 and cantilevers therefrom. Typically, the suspension 828 is biased generally toward its corresponding data storage disk 806 by a spring-like force. The slider 826 is disposed at or near the free end of each suspension 828. What is commonly referred to as the read-write head (e.g., transducer) is appropriately mounted as a head unit (not shown) under the slider 826 and is used in hard disk drive read/write operations. The head unit under the slider 826 may utilize various types of read sensor technologies such as anisotropic magnetoresistive (AMR), giant magnetoresistive (GMR), tunneling magnetoresistive (TuMR), other magnetoresistive technologies, or other suitable technologies.

The head unit under the slider 826 is connected to a preamplifier 830, which is interconnected with the control electronics 820 of the hard disk drive 800 by a flex cable 832 that is typically mounted on the actuator arm assembly 812. Signals are exchanged between the head unit and its corresponding data storage disk 806 for hard disk drive read/write operations. In this regard, the voice coil motor 818 is utilized to pivot the actuator arm assembly 812 to simultaneously move the slider 826 along a path 834 and across the corresponding data storage disk 806 to position the head unit at the appropriate position on the data storage disk 806 for hard disk drive read/write operations.

When the hard disk drive 800 is not in operation, the actuator arm assembly 812 is pivoted to a “parked position” to dispose each slider 826 generally at or beyond a perimeter of its corresponding data storage disk 806, but in any case in vertically spaced relation to its corresponding data storage disk 806. In this regard, the hard disk drive 800 includes a ramp assembly (not shown) that is disposed beyond a perimeter of the data storage disk 806 to both move the corresponding slider 826 vertically away from its corresponding data storage disk 806 and to also exert somewhat of a retaining force on the actuator arm assembly 812.

Exposed contacts 836 of a drive connector 838 along a side end of the hard disk drive 800 may be used to provide connectivity between circuitry of the hard disk drive 800 and a next level of integration such as an interposer, a circuit board, a cable connector, or an electronic assembly. The drive connector 838 may include jumpers (not shown) or switches (not shown) that may be used to configure the hard disk drive 800 for user specific features or configurations. The jumpers or switches may be recessed and exposed from within the drive connector 838.

As such, provided herein is an apparatus, including a stator assembly including a number of stator teeth; a number of field coils singly disposed on the number of stator teeth; a base configured to support the stator assembly; and a back iron coupled to a hub, wherein the hub is configured to rotate about an axis normal to the base. The apparatus further includes a magnet in the form of a magnetic annulus proximate to each of the number of stator teeth, wherein the number of field coils are operable to cause the hub to rotate via the magnetic annulus. Thus, the stator assembly is operable to cause the magnet to rotate. The magnet is co-formed on the back iron. In some embodiments, a coating surrounds the back iron and the magnetic annulus (e.g. the magnet) thereby acting as a protective coating.

In some embodiments, the back iron includes a first cavity and the magnet is a magnetic annulus is in the first cavity. In some embodiments, the apparatus further includes a second magnetic annulus, wherein the back iron includes a second cavity and the second magnetic annulus is in the second cavity of the back iron. In some embodiments, the second magnetic annulus is in a bottom portion of the back iron. In some embodiments, the second magnetic annulus is operable for axial biasing of the hub. In some embodiments, the back iron is operable to provide structural strength to the magnetic annulus (e.g. the magnet). In some embodiments, the magnetic annulus is in contact with a vertical portion of the back iron. In some embodiments the magnet is co-formed to a vertical portion of the back iron.

Also provided is an apparatus, including a stator assembly including a number of stator teeth; a number of field coils singly disposed on the number of stator teeth; and a base operable to support the stator assembly. The apparatus further includes a back iron coupled to a hub, wherein the hub is operable to rotate about an axis normal to the base, and wherein the back iron includes a first annular channel; and a first magnetic ring proximate to each of the number of stator teeth, wherein the magnet is formed in the first annular channel of the back iron. In some embodiments, the magnet is a magnetic annulus that is co-formed to the back iron.

In some embodiments, the back iron is coupled to three sides of the magnetic annulus. In some embodiments, a portion of the first magnetic ring extends outside of the first annular channel. In some embodiments, the first annular channel is in a vertical portion of the back iron. In some embodiments, the apparatus further includes a second annular channel in the back iron; and a second magnetic ring, wherein the second magnetic ring is formed in the second annular channel. In some embodiments, the second magnetic ring is formed in a bottom portion of the back iron and the second magnetic ring is operable for axial biasing of the hub. In some embodiments, an inner surface of the first magnetic ring is vertically flush with a vertical portion of the back iron. In some embodiments, the top and bottom of the magnetic annulus are not surrounded by the back iron and are therefore substantially free from the back iron.

Also is provided is a method, including forming a back iron; applying magnetic material to a portion of the back iron; magnetizing the magnetic material to produce a magnet; and coupling the back iron to a hub of an electric motor. In some embodiments, a mold cavity is formed and defined with the back iron and a mold. In some embodiments, the magnetic material is injected into the cavity and co-formed onto the back iron. In some embodiments, the back iron defines three sides of the mold cavity.

In some embodiments, the magnetic material is applied directly to the back iron. In some embodiments, the method further includes applying a coating around the back iron and the magnet. In some embodiments, the magnetic material is applied to the back iron with a mold. In some embodiments, the back iron includes another mold cavity (e.g. a second mold) on a bottom portion of the back iron, and the magnetic material is applied into the second cavity. In some embodiments, another mold cavity is formed with the back iron and the mold. In some embodiments, the magnetic material is co-formed to another mold cavity in the back iron.

While embodiments have been described and/or illustrated by means of examples, and while these embodiments and/or examples have been described in considerable detail, it is not the intention of the applicant(s) to restrict or in any way limit the scope of the embodiments to such detail. Additional adaptations and/or modifications of the embodiments may readily appear in light of the described embodiments, and, in its broader aspects, the embodiments may encompass these adaptations and/or modifications. Accordingly, departures may be made from the foregoing embodiments and/or examples without departing from the scope of the embodiments. The implementations described above and other implementations are within the scope of the following claims.

What is claimed is:

1. An apparatus comprising:
a stator assembly including a stator tooth;
a base configured to support the stator assembly;
a back iron coupled to a hub, wherein the hub is configured to rotate about an axis normal to the base; and
a magnet proximate to the stator tooth, wherein
the stator assembly is operable to cause the magnet to rotate, and
the magnet is co-formed on the back iron.

2. The apparatus of claim 1, wherein a coating surrounds the back iron and the magnet.

3. The apparatus of claim 1, wherein the back iron comprises a first cavity and the magnet is a magnetic annulus in the first cavity.

4. The apparatus of claim 3, further comprising:
a second magnetic annulus, wherein the back iron comprises a second cavity and the second magnetic annulus is in the second cavity of the back iron.

5. The apparatus of claim 4, wherein the second magnetic annulus is in a bottom portion of the back iron.

6. The apparatus of claim 5, wherein the second magnetic annulus is operable for axial biasing of the hub.

7. The apparatus of claim 1, wherein the back iron is configured to provide structural strength to the magnet.

8. The apparatus of claim 1, wherein the magnet is co-formed to a vertical portion of the back iron.

9. An apparatus, comprising:
a hub;
a back iron coupled to the hub; and
a magnetic annulus co-formed to the back iron.

10. The apparatus of claim 9, wherein the back iron is coupled to three sides of the magnetic annulus.

11. The apparatus of claim 9, further comprising an annular channel in a vertical portion of the back iron.

12. The apparatus of claim 9, further comprising:
a first annular channel in the back iron;
a second annular channel in the back iron; and
a magnetic ring, wherein the magnetic ring is in the second annular channel.

13. The apparatus of claim 12, wherein
the second annular channel is formed in a bottom portion of the back iron, and
the magnetic ring is operable for axial biasing of the hub.

14. The apparatus of claim 9, wherein a top and bottom of the magnetic annulus are substantially free from the back iron.

15. A method comprising:
defining a mold cavity with a back iron and a mold;
co-forming magnetic material onto the back iron in the mold cavity;
magnetizing the magnetic material to produce a magnet; and
coupling the back iron to a hub.

16. The method of claim 15, further comprising injecting the magnetic material into the mold cavity.

17. The method of claim 15, wherein the back iron defines three sides of the mold cavity.

18. The method of claim 15, further comprising applying a coating around the back iron and the magnet.

19. The method of claim 15, further comprising forming another mold cavity with the back iron and the mold.

20. The method of claim 15, further comprising co-forming the magnetic material to another mold cavity in the back iron.
